(19) United States
(12) Patent Application Publication
(10) Pub. No.: US 2016/0039686 A1
(43) Pub. Date: Feb. 11, 2016

(54) WASTEWATER TREATMENT METHOD, MEMBRANE DISTILLATION MODULE AND WASTEWATER TREATMENT APPARATUS

(71) Applicant: SUMITOMO ELECTRIC INDUSTRIES, LTD., Osaka-shi, Osaka (JP)

(72) Inventors: Atsushi YAMAGUCHI, Osaka (JP); Toru MORITA, Osaka (JP)

(21) Appl. No.: 14/782,619

(22) PCT Filed: Nov. 26, 2014
(86) PCT No.: PCT/JP2014/081168

§ 371 Date: Oct. 6, 2015

(30) Foreign Application Priority Data
Nov. 27, 2013 (JP) 2013-245465

(51) Int. Cl. C02F 1/44; B01D 61/36; B01D 63/06; B01D 71/32; B01D 63/02

(52) U.S. Cl. CPC C02F 1/447; B01D 71/32; B01D 63/02; B01D 63/06; B01D 61/364; B01D 2325/38; C02F 2103/10

(57) ABSTRACT

Provided is a method for purifying wastewater containing an oil component, a salt component, and an organic matter produced when extracting petroleum from a stratum or a bedrock layer, including performing membrane distillation using a fluorine-based resin hydrophobic porous membrane made of PTFE (polytetrafluoroethylene), PVDF (polyvinylidene difluoride) or PCTFE (polychlorotrifluoroethylene) and having a practical maximum operating temperature exceeding 100° C., and simultaneously removing the oil component, the salt component and the organic matter contained in the wastewater.

### TECHNICAL FIELD

The present invention relates to a wastewater treatment method, a membrane distillation module used for the wastewater treatment method, and a wastewater treatment apparatus including the membrane distillation module, which are suitably used particularly for reusing and purifying oil-containing salt-containing wastewater generated when producing oil from a general oil field, shale oil and shale gas.

### BACKGROUND ART

Various wastewater treatment apparatuses and various methods for removing oil component from oil-containing wastewater for purification have been conventionally offered.

When extracting oil from a general oil field or extracting shale oil and shale gas from underground, high-pressure water is injected into a stratum or a bedrock in order to facilitate recovering oil and gas. If the oil component has high viscosity, high-temperature steam is injected. In this way, high-pressure water is injected or steam is injected to reduce the viscosity of the oil component for recovery as a mixed fluid, and the oil component is obtained by separation from the recovered mixed fluid. The wastewater from which the oil component has been separated is called “oil-field produced water”, which is produced in a large amount. Particularly, in an old oil field, oil-field produced water may amount to several times to 10 times of the amount of petroleum exploited, and treatment of this large amount of oil-field produced water is a matter of concern.

That is, oil-field produced water contains a large amount of a salt component, heavy metal, silica, bacteria, organic matters injected at the time of exploitation, and the like, in addition to an oil component. The oil-field produced water is disposed of underground, or produced water that cannot be disposed of occupies a large area, and is stored in a pond in many cases. However, the oil-field produced water may be unable to be disposed of depending on the place. Specifically, it is a case where disposal is geologically difficult, specifically, when there is an underground water vein, and mixture with the underground water will arise concern. On the other hand, in areas suffering from serious water shortage, particularly in inland areas distant from the sea area and lacking in well water, including countries in the Middle East, the produced water may have to be used as a water source for industrial water and the like. On that occasion, however, it is necessary to remove many impurities, such as an oil component and a salt component. This requires many water treatment processes, which requires great capital investment.

In order to raise the water quality of such oil-field produced water to an industrial-water level, a mixed fluid with an oil component recovered from an oil well is separated by gravity into oil and wastewater with a three-phase separator 100, and then after performing a primary treatment of separating the oil component and solid with a hydrocyclone, and a treatment through a coagulation sedimentation tank, a dissolved air flotation plant, a Media filter, a nut shell filter, and the like, it is necessary to perform a tertiary treatment through microfiltration (MF filtration) or a ultrafiltration membrane, and further, a desalination treatment by reverse osmosis with an RO membrane, and the like, as shown in FIG. 4 at (A). Since the equipment cost for ensuring the amount of treated water increase as treatments advance from the primary, secondary, tertiary, and desalination treatments, a problem arises in that the investment profitability of treatment of oil-field produced water discharged in a large amount degrades. Moreover, in the treatment of oil-field produced water discharged in a large amount, it is in many cases difficult to apply precise membrane separation with a precise MF membrane, reverse osmosis membrane treatment with an RO membrane, and the like, in terms of their processing speeds.

In addition, for a microfiltration membrane, oil-field produced water often has a high temperature at the time of discharge, and for example, when oil-containing wastewater of 60° C. or above is always supplied, a membrane filter made of PP, PE or PVDE resin which has conventionally been used widely for the oil-water separation treatment does not have sufficient heat resistance.

Furthermore, since decrease in flow rate is caused by the oil component adhering to the membrane surface of the membrane filter, chemical cleaning using a strong alkali agent, such as sodium hydroxide, is indispensable. However, a problem arises in that the membrane filter made of resin or a ceramic membrane has low durability against a high-concentration alkaline aqueous solution, resulting in insufficient chemical cleaning.

To solve the above-described problems, the applicant of the present application provides a separation membrane module in which a hollow fiber membrane made of fluorine-based resin selected from among PTFE (polytetrafluoroethylene), PSF (polysulfone) and PBS (polyether sulfone) having excellent heat resistance and chemical resistance is used as a membrane filter to subject oil-containing wastewater to membrane filtration, in Japanese Patent Laying-Open No. 2010-36183 (PTD 1).

### CITATION LIST

### Patent Document

### PTD 1: Japanese Patent Laying-Open No. 2010-36183

### SUMMARY OF INVENTION

### Technical Problem

Since the hollow fiber membrane of fluorine-based resin, sulfone-based resin or the like is used for membrane filtration, the separation membrane module described in PTD 1 has advantages in that thermal degradation can be reduced because of its heat resistance even if oil-containing wastewater has a high temperature and in that cleaning using a strong alkali agent can be performed because of its chemical resistance.

However, it is impossible to remove a dissolved material, for example, a salt component and the like which should be removed. Further, for a desalination process adopted in a subsequent stage, if more than or equal to 500 mg/L of salt component is contained, ion exchange resin cannot be used, and if more than or equal to 45000 mg/L of salt component is contained, separation cannot be achieved efficiently even with an RO membrane. Therefore, after membrane filtration, it is necessary to further perform desalination through an evaporator or the like.

Furthermore, also as to a microfiltration membrane, since wastewater is passed through holes of a membrane filter, the holes may be blocked depending on the size of solid matters and the viscosity of the oil component contained in the wastewater. Thus, occurrence of clogging cannot be completely prevented. Clogging results in reduced permeate flow rate. Moreover, the membrane filter cannot remove organic matters, such as naphthenic acid, which is a low-molecular organic matter contained in oil-sand wastewater or the like, for example.

The present invention was made in view of the above-described problems, and has an object to provide an oil production system, in which after separating a mixed fluid of oil extracted from an oil well and injected water into oil and wastewater with a separator, wastewater can be purified by a simple step without performing a multi-stage process. The system has purification performance capable of simultaneously removing an oil component, a salt component, low-molecular organic matters, and the like contained in wastewater, and has durability against strong alkali agents and excellent heat resistance. The system is also capable of performing high-performance purification over a long period of time.

### Solution to Problem

In order to solve the above-described subject, as a first invention, a method for purifying wastewater containing an oil component, a salt component, and an organic matter produced when extracting petroleum from a stratum or a bedrock layer is provided. The method includes subjecting wastewater separated after recovering oil from oil-containing mixed water extracted from an oil well by a separator, to membrane distillation using a fluorine-based resin hydrophobic porous membrane made of one of PTFE (polytetrafluoroethylene), PVDF (polyvinylidene difluoride) and PCTFE (polychlorotrifluoroethylene) and having a practical maximum operating temperature exceeding 100° C., and simultaneously removing the oil component, the salt component and the organic matter contained in the wastewater.

While oil-containing wastewater is treated by membrane filtration using the hollow fiber membrane made of fluorine-based resin selected from among PTFE, PSF, and PES in PTD 1, in the present invention, wastewater is treated using the membrane distillation process in which water is not allowed to permeate therethrough but only steam is allowed to permeate therethrough using the hydrophobic porous membrane made of fluorine-based resin. In this membrane distillation, minute foreign matters can be removed similarly to microfiltration, and also a salt component and water-soluble organic matters containing naphthenic acid and the like which cannot be removed with a membrane filter can be removed. Therefore, the need for desalination and softening treatment through hardness component removal or the like which is required after filtration treatment in PTD 1 can be eliminated.

In order to perform microfiltration with a MF membrane, after separating a mixed fluid extracted from an oil well with a separator by gravity, a hydrocyclone, coagulation sedimentation, floatation, and Media filtering are necessary as pretreatment, as described above. However, the use of membrane distillation will hardly arise the problem of occurrence of clogging in the membrane. Thus, membrane distillation can be performed without the multi-stage pretreatment after separation with a separator, as shown in FIG. 4 at (B). In this way, the multi-stage pretreatment step after the separator can be reduced to a single-stage treatment step to significantly shorten the treatment step. As a result, equipment can be simplified, and significant shortening of treatment time can be achieved.

Preferably, the wastewater held at 60° C. to 100° C. is flown to the one surface side of the hydrophobic porous membrane at a pressure A by a pump, and treated liquid held at 5° C. to 40° C. is flown to the other surface side at a pressure B by a pump, wherein a relation of pressure A<pressure B is met.

The membrane distillation only allows steam produced from wastewater to permeate through holes of the distillation membrane, using the saturation vapor pressure difference resulting from the temperature difference between fluids flowing on the both sides of the distillation membrane implemented by a hydrophobic porous membrane as driving sources. As the temperature difference, namely, the saturation vapor pressure difference increases, membrane distillation can be performed efficiently. Therefore, membrane distillation from the wastewater side to the treated liquid side can be performed more efficiently as the wastewater has a higher temperature and the treated liquid obtained by liquefaction of steam has a lower temperature.

When wastewater is a high-temperature wastewater of 60° C. to 100° C., it is not necessary to heat the wastewater before the membrane distillation step. Even if it is necessary to heat the wastewater to a temperature lower than a required temperature, thermal dose is small. Using inexpensive heat energy, such as solar heat or heated effluent, cost reduction can be achieved.

Each of the oil component, the organic matter including a soluble component, and the salt component contained in treated liquid having been subjected to the membrane distillation becomes less than 1 mg/l. In this way, since the salt component can also be removed together with the oil component, it is not necessary to desalinate treated water having been subjected to membrane distillation using an evaporator or a hardness component removal device as described above.

More preferably, high-temperature wastewater and treated liquid are discharged from the membrane distillation module during stop of circulation of the wastewater and the treated liquid, and thereafter dry air is blown.

The wastewater treatment method of the present invention is particularly suitably used for treating wastewater containing an oil component, a salt component and an organic matter produced in a step of producing oil including heavy oil, shale oil, and oil produced from shale gas or the like.

As a second invention, provided as a membrane distillation module for use in the wastewater treatment method of the first invention is a membrane distillation module having an oil-repellent layer provided on a surface of the hydrophobic porous membrane made of fluorine-based resin to be in contact with the wastewater, the oil-repellent layer holding an oil-repellent polymer.

In particular, in order to treat high-temperature wastewater, the fluorine-based resin having heat resistance whose practical maximum operating temperature exceeds 100° C. is used suitably.

Specifically, examples of the fluororesin include PTFE (polytetrafluoroethylene), PVDF (polyvinylidene difluoride), or PCTFE (polychlorotrifluoroethylene). The melting point serving as an index of heat resistance is 327° C. for PTFE, 155 to 175° C. for PVDF, and 220° C. for PCTFE. The angle of contact with water serving as an index of water repellency thereof is 114° for PTFE, 82° for PVDF, and 84° for PCTFE.

Therefore, the PTFE is particularly desirable when oil-containing wastewater to be treated has a high temperature of 60° C. to 100° C. Further, the PTFE has chemical resistance, particularly alkali resistance and oxidation resistance. In order to remove an oil component, organic matters and the like adhering to the surface of the distillation membrane in contact with high-temperature wastewater, they need to be removed by dissolution or stripping by chemical cleaning with a strong alkaline aqueous solution, a hydrogen peroxide solution or the like, so that the wastewater is reproduced repeatedly. Therefore, alkali resistance and oxidation resistance are important physical properties, and a PTFE membrane having these properties-allows treatment performance to be maintained over a longer period of time.

As described above, the expanded PTFE porous membrane is used most suitably because of its excellent heat resistance, strength and cleaning chemical resistance. Preferably, the porous membrane made of the expanded PTFE has a form of (1) a hollow fiber membrane, (2) a tubular porous membrane obtained by winding a porous sheet and securing wound ends by sealing to represent a cylindrical shape, or (3) a bag-like composite membrane obtained by sealing, such as by heat sealing, both ends of two porous membranes laminated on both surfaces of a dissimilar material, such as a nonwoven fabric, a flow path material, such as a net, being included on the inner side of the composite membrane.

The expanded PTFE membrane itself in the form of each of (1) to (3) is set to have an average hole diameter of 0.01 μm to 1 μm. The porosity is 40% to 90%, preferably 65% to 85%, and more preferably 70 to 80%. The reason for setting the porosity at 40 to 90% is as follows: a membrane having a higher porosity is desirable in terms of steam permeability because the diffusion resistance is lower, and the speed is faster. As to holding of an oil repellent agent, higher porosity results in a larger specific surface area, and hence a larger holding force, by which stable holding is easier to achieve.

When the hollow fiber membrane (1) is adopted, it is preferable to set the inner diameter at 0.5 mm to 10 mm, and the thickness at 0.3 to 1 mm. When the tubular porous membrane (2) is adopted, it is preferable to set the inner diameter at 3 mm to 20 mm, and the thickness at 30 μm to 1 mm. The composite membrane (3) preferably has a thickness of 10 μm to 5 mm.

The hollow fiber membrane (1), the tubular porous membrane (2) or the composite membrane (3) made of the expanded PTFE porous material desirably has a high strength. Therefore, it is preferable that a tensile strength at 25° C. be more than or equal to 30N, preferably more than or equal to 50N, and the upper limit is about 1.50N.

The tensile strength was in conformity with JIS K 7161, and the hollow fiber membrane itself was used as a test piece. Measurement was performed setting the pulling rate during the test at 100 mm/min and the gauge length at 50 mm.

When the tensile strength is set at more than or equal to 30N, a highly reliable operation is also possible in membrane distillation always operated at high temperature, over a long period of time without leakage that would be caused by membrane cracking and the like.

Because of the chemical resistance, even if a high-concentration alkali cleaning solution or an oxidation-resistant cleaning solution is repeatedly used, the membrane will not degrade in treatment capacity and strength, and a high-performance purifying function can be maintained over a long period of time.

It is desirable to provide an oil-repellent layer at least on the surface of the hydrophobic porous membrane of the present invention to be in contact with high-temperature wastewater. By providing the oil-repellent layer, a soluble organic matter, a surface active agent, a solvent, and an organic component, such as an oil component, particularly contained in wastewater can be repelled, and it is possible to prevent contamination due to their adhesion to the membrane which would cause moistening of the membrane, thereby providing stable membrane distillation performance without moistening the membrane over a long period of time.

The oil-repellent function as used herein means that, for example, when a hollow fiber membrane is immersed in 100% n-hexane for impregnation, hexane does not enter holes in the membrane surface visually, that is, the membrane is not moistened. By another index, it means that the rate of change in ventilating performance of the membrane does not substantially vary.

In the oil-repellent layer provided on the surface of the hydrophobic porous membrane, a polymer having a fluorinated alkyl side chain is preferably held in the hydrophobic porous body.

A method that can be adopted as a method for providing the oil-repellent layer on the surface of the hydrophobic porous membrane is to impregnate a porous membrane with a solution by a technique of preparing the solution in which a fluorination monomer or further a polymerization initiator has been dissolved, and immersing a porous membrane in that solution, or a technique of forming a module by a porous membrane, and then injecting this solution into the porous material, and then to remove the solvent by volatilization. In implementation, by dissolving a monomer and then diluting it with a solvent to set the concentration properly, a proper amount can be held without a porous portion being clogged. On the other hand, at least one of the surfaces of the hydrophobic porous base membrane is impregnated with a solvent containing a proper concentration of a substance having already become a polymer dissolved therein or the solvent is applied to the one surface, and then dried, or the above-mentioned substance is deposited with a poor solvent. The oil-repellent layer can also be obtained by carrying out this step after forming a membrane module.

As described above, since the distillation membrane used in the present invention has the oil-repellent layer provided on the surface of the hydrophobic porous membrane, a large amount of oil component contained in high-temperature wastewater separated from a heated bitumen-mixed fluid can be reduced/prevented from adhering to the surface of the distillation membrane. As a result, troubles, such as performance degradation that would be caused by moistening due to contamination of the membrane and leakage, which are considered as drawbacks of membrane distillation, can be prevented. Moreover, maintenance frequency can be reduced to reduce running cost, and productivity can be improved.

Preferably, in the hydrophobic porous membrane used for the membrane distillation, a circulative path for high-temperature wastewater is provided on the outer surface of the hollow fiber membrane (1), the tubular porous membrane (2) or the composite membrane (3), and the inner surface side isolated by the membrane serves as a circulative path for the cooling water.

In the case of the hollow fiber membrane (1) and the tubular porous membrane (2), water can be flown in the reverse direction.

However, when treating wastewater containing a large amount of solid content, the hollow fiber membrane or the tubular porous membrane has the oil-repellent layer on the outer surface where heated wastewater containing an oil component, a salt component, and organic matters is flown, and steam passes through the hollow portion, which serves as a passage of cooling water produced by liquefied steam. With this structure, the hollow portion is unlikely to be clogged by the solid matter or oil component in wastewater, and the cooling water flows favorably. Thus, a deflection is unlikely to occur, and the temperature difference is made uniform, so that membrane distillation capability can be stabilized ensuring the temperature difference stably.

Furthermore, as a third invention, the present invention provides a wastewater treatment apparatus including the membrane distillation module of the second invention. A wastewater reservoir, a pump and a heater are inserted in a circulative path for the wastewater. The wastewater reservoir is exposed to the atmosphere. A heat exchanger, a treated liquid tank and a pump are inserted in a circulative path for the treated liquid. Treated liquid produced from steam having permeated through the hydrophobic porous membrane is adjusted in temperature by the heat exchanger and captured into the treated liquid tank. Part of the treated liquid stored in the treated liquid tank is supplied by the pump to the circulative path to be used for liquefaction of the steam having permeated through the hydrophobic porous membrane.

### Advantageous Effects of Invention

As described above, according to the present invention, wastewater produced in an oil production process of producing oil from a general oil field, shale oil or shale gas is purified, and the membrane distillation process is adopted. Thus, an oil component can be removed, and a salt component and an organic matter can be removed simultaneously. Therefore, the need for desalination and softening steps by a hardness component removal device or an evaporator which is required in membrane filtration can be eliminated. Since the holes of a hydrophobic porous membrane used for membrane distillation are micropores that do not allow water to permeate therethrough, but only allow steam to permeate therethrough, occurrence of clogging caused by foreign matters in the membrane filter can be prevented, and the surface of the hydrophobic porous membrane brought into contact with wastewater only needs to be cleaned. Therefore, maintenance frequency can be reduced significantly to extend continuous operating time, which can improve productivity.

### BRIEF DESCRIPTION OF DRAWINGS

FIG. 1 shows an embodiment of a membrane distillation module of the present invention, a vertical sectional view shown at (A), an expanded perspective view of a hollow fiber membrane shown at (B), and a membrane distillation function of the hollow fiber membrane shown at (C).

FIG. 2 is an overall view of a wastewater treatment apparatus including the membrane distillation module.

FIG. 3 is a partial perspective view of a tubular porous membrane used for membrane distillation.

FIG. 4 shows a flowchart of a process of a conventional example at (A), and a flowchart of a process of the present invention in contrast with the process of the conventional example at (B).

### DESCRIPTION OF EMBODIMENTS

Hereinafter, an embodiment of the present invention will be described with reference to the drawings.

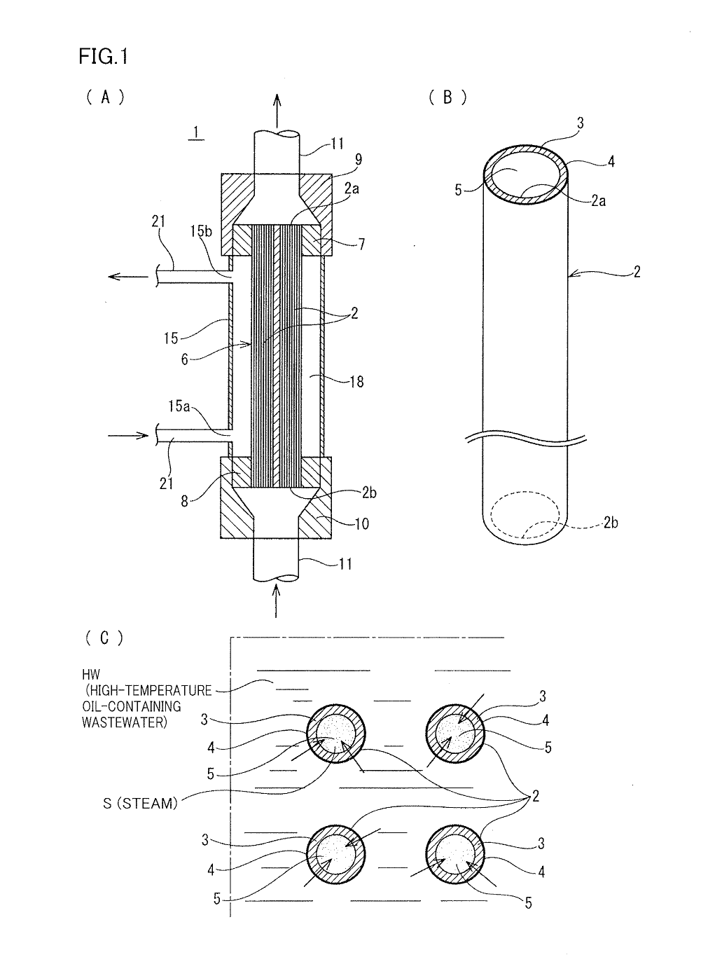

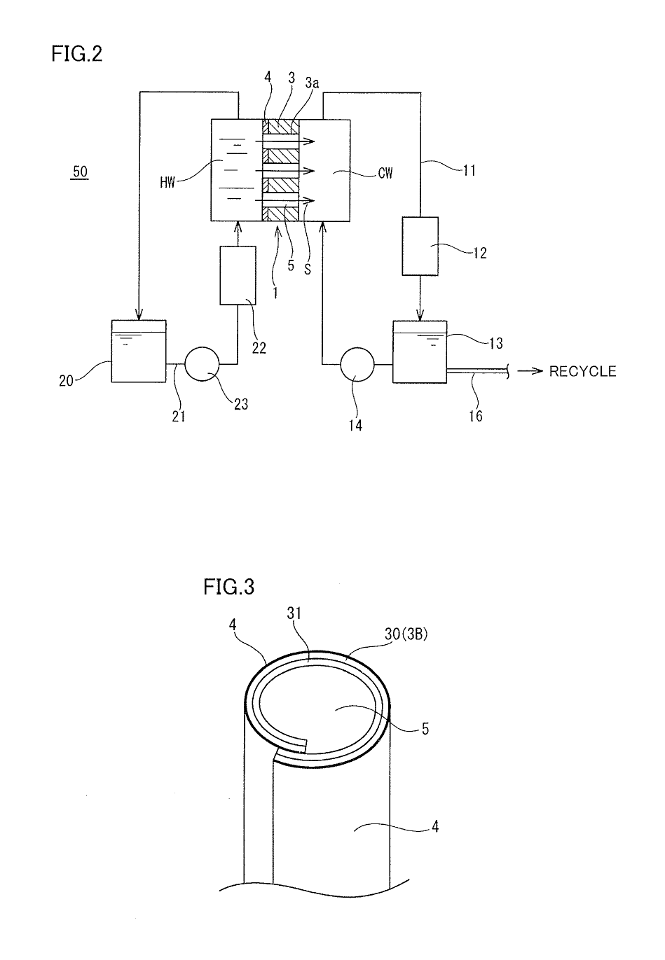

In a wastewater treatment apparatus of the present embodiment, wastewater produced in an oil production system of injecting water into an oil field to recover oil is purified using a wastewater treatment apparatus 50 shown in FIG. 2 including a membrane distillation module 1 shown in FIG. 1.

A large amount of wastewater containing an oil component, a salt component and soluble organic matters produced in the oil production system is purified until each of the oil component, salt component, soluble organic matters, and the like is reduced to less than 1 mg/l through membrane distillation.

As shown in FIG. 1, membrane distillation module 1 adopts, as a distillation membrane, a hollow fiber membrane 2 made of an expanded PTFE as a hydrophobic porous membrane serving as a base membrane 3 and an oil-repellent layer 4 being provided on the outer peripheral surface of base membrane 3. Oil-repellent layer 4 is provided by applying a coating liquid made of polymer having a fluorinated alkyl side chain having the oil-repellent function in such a mode that holes 3a (shown in FIG. 3) of base membrane 3 are not closed. Hollow fiber membrane 2 for membrane distillation has an average hole diameter ranging from 0.01 μm to 1 μm in order not to allow water to permeate therethrough but only allow steam to permeate therethrough.

As shown in FIG. 1 at (C) and FIG. 2, in hollow fiber membrane 2, the outer peripheral surface where oil-repellent layer 4 is provided comes into contact with high-temperature wastewater HW containing an oil component, and only steam S having permeated through the membrane shall be flown into a hollow portion 5 of hollow fiber membrane 2, and water shall not.

Hollow portion 5 has an inner diameter of 0.5 mm to 4 mm and an outer diameter of 1 mm to 5 mm. Hollow fiber membrane 2 has a thickness including oil-repellent layer 4 of 10 μm to 5 mm, an overall length of 1000 mm to 2500 mm, a porosity of 40 to 90%, and a tensile strength of 30 to 150N.

As shown in FIG. 1 at (A) and (C), membrane distillation module 1 has an assembled bundle 6 in which a plurality of hollow fiber membranes 2 are arranged at required intervals of 0.5 mm to 20 mm. The upper and lower both ends of this assembled bundle 6 are fixed by upper and lower fixing plates 7 and 8 with upper and lower openings 2a and 2b of each hollow fiber membrane 2 being open. Caps 9 and 10 are fitted over upper and lower fixing plates 7 and 8, respectively, and the both ends of a circulative cooling pipe 11 are connected to caps 9 and 10. Hollow portion 5 of each hollow fiber membrane 2 serves as a path for treated liquid obtained by liquefaction of steam S having permeated, and communicates at its upper and lower openings with circulative cooling pipe 11, so that hollow portion 5 serves as part of the path for circulating cooling water.

An outer casing 15 for coupling upper and lower fixing plates 7 and 8 is attached to surround assembled bundle 6 leaving space which serves as a wastewater circulative path 18. Openings provided on the upper and lower both sides of this outer casing 15 serve as an inlet 15a and an outlet 15b communicating with a wastewater circulative pipe 21.

Wastewater treatment apparatus 50 shown in FIG. 2 including membrane distillation module 1 has a heat exchanger 12, a treated liquid tank 13 and a circulative pump 14 inserted in circulative cooling pipe 11 of membrane distillation module 1. Circulative cooling pipe 11 is arranged in the atmosphere to cool steam permeated into hollow portion 5 through membrane distillation. If the fluid in circulative cooling pipe 11 has a temperature more than or equal to a required temperature, heat exchanger 12 cools the fluid to adjust the temperature to assume the required temperature. A supply pipe 16 for various reuses such as re-injection is coupled to treated liquid tank 13. Part of the treated liquid in this treated liquid tank 13 is circulated to hollow portion 5 of hollow fiber membrane 2 of membrane distillation module 1, and most of the remaining part is flown to the supply pipe for reuse.

A wastewater reservoir 20, a circulative pump 23, and a heater 22 are inserted in wastewater circulative pipe 21 for circulating high-temperature oil-containing wastewater HW (hereinafter abbreviated to wastewater HW). Wastewater reservoir 20 is an atmosphere-exposed tank, and releases pressure of stored wastewater HW. When the temperature of supplied wastewater is lower than or equal to a temperature within a set range, the wastewater is heated by heater 22 to be adjusted to have a temperature within the set range.

Wastewater HW supplied on the outer peripheral surface of hollow fiber membrane 2 of membrane distillation module 1 is set to be held in a temperature range of 60° C. to less than 100° C., and to be supplied at a pressure A (20 to 300 KPa) by circulative pump 23. Treated liquid CW supplied to hollow portion 5 of hollow fiber membrane 2 of membrane distillation module 1 is set to be held at 5° C. to 40° C., and to be supplied at a pressure B (30 to 400 KPa) by circulative pump 14. That is, heated wastewater HW on the outer peripheral side of the hollow fiber membrane for membrane distillation and treated liquid CW on the hollow portion side on the inner periphery are set to have a temperature difference of 20° C. to 70° C., a relation of pressure A<pressure B, and a pressure difference of 10 to 100 KPa.

Next, the function of wastewater treatment apparatus 50 including membrane distillation module 1 will be described.

In membrane distillation module 1, only steam S produced from wastewater HW continuously supplied to outer casing 15 at a required pressure is allowed to permeate through hollow fiber membrane 2 to flow into hollow portion 5, but water is not, so that water does not flow into hollow portion 5. Since hollow portion 5 communicates with circulative cooling pipe 11, and treated liquid CW flows therein by pump 14, permeated steam S comes into contact with treated liquid CW and is liquefied. This treated liquid CW is stored in treated liquid tank 13. Treated liquid CW in treated liquid tank 13 is supplied to a recycle step through pipe 16. Part of treated liquid CW in treated liquid tank 13 is circulated to hollow portion 5 of hollow fiber membrane 2 through circulative cooling pipe 11.

Since hollow fiber membrane 2 of membrane distillation module 1 has oil-repellent layer 4 disposed on the outer peripheral surface to be in contact with wastewater 14W, an oil component is unlikely to adhere, which can reduce/prevent any adhering oil to block the holes of hollow fiber membrane 2. Thus, reduction in membrane distillation capability can be restrained/prevented.

Treated liquid CW purified in membrane distillation module 1 is purified to such an extent that an oil component, a salt component and organic matters including naphthenic acid are each contained only by less than or equal to 1 mg/liter.

In membrane distillation module 1, oil-repellent layer 4 is provided on the outer peripheral surface of hollow fiber membrane 2 to be in contact with wastewater HW to reduce/prevent adhesion of the oil component. However, in order to stably maintain the permeate flow rate of steam over a long period of time, it is necessary to conduct periodical cleaning.

Hollow fiber membrane 2 made of PTFE used for the present invention has excellent chemical resistance, and is subjected to chemical cleaning in order to remove an adhering oil component. As the cleaning chemical, 1 to 20% of caustic soda solution, sodium hypochlorite, hydrogen peroxide solution, or the like is used suitably.

Furthermore, wastewater HW and treated liquid CW are discharged from membrane distillation module 1 during stop of circulation of wastewater HW and treated liquid CW, and then, dry air is blown to maintain the temperature in membrane distillation module 1 so as not to be frozen.

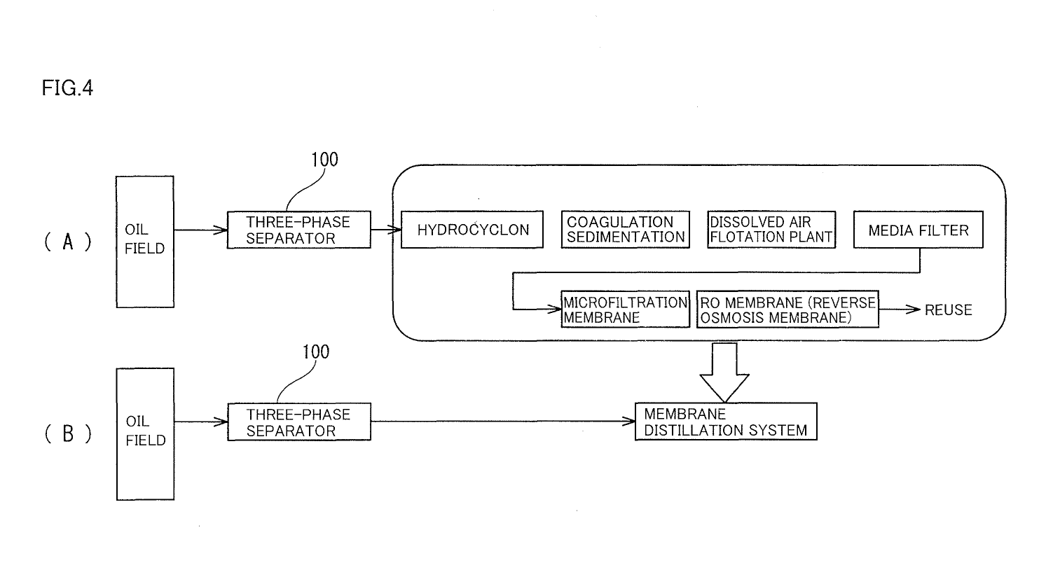

Adopting wastewater treatment apparatus 50 including membrane distillation module 1, wastewater can be purified in the oil production step by the wastewater treatment apparatus including the membrane distillation module after separating the mixed fluid extracted from an oil well into oil and wastewater by separator 100, with multi-stage pretreatment shown in FIG. 4 at (A) skipped, as shown in FIG. 4 at (B). Moreover, a desalination step using an ion exchange resin, an evaporator, an RO membrane, or the like is unnecessary after the purification in this membrane distillation module, and the purified wastewater can be reused. Thus, the process for purifying wastewater can be significantly reduced. Specifically, the following characteristic operation effects (1) to (4) are achieved.

(1) The oil component, salt component, and organic matters including soluble organic matters can be removed to reduce the oil component, salt component and organic matters to be less than 1 mg/L, respectively.

(2) By significantly removing the oil component, scale trouble caused by organic matters in the apparatus and pipes for reheating the treated liquid is reduced.

(3) Since the salt component can also be removed through membrane distillation, which eliminates the need for the desalination step by an ion exchanger, a hardness component removal device or an evaporator which has conventionally been required.

(4) When a PTFE membrane is used for membrane distillation, the membrane has heat resistance that can be used even when the temperature of high-temperature wastewater HW is 200° C., and the high-temperature wastewater can be supplied to the membrane distillation module without cooling, which can significantly reduce heat loss. When a membrane made of ceramics is used, such a membrane has problems in crack resistance due to rapid temperature rise/fall, alkali resistance in connection with chemical cleaning, handling ability associated with weight, size, lack of flexibility, and avoidance of freezing, and economical efficiency, but the problems can be overcome by using a PTFE membrane.

A variation of a hydrophobic porous membrane for use in the membrane distillation module is shown in FIG. 3.

In this hydrophobic porous membrane, an expanded PTFE sheet is wound and wound ends are secured by sealing to obtain a tubular porous membrane serving as base membrane 30, instead of using a hollow fiber membrane. Oil-repellent layer 4 is provided on the outer peripheral surface of this base membrane 30, and a support layer 31 made of a nonwoven fabric is provided on the inner peripheral surface. Hollow portion 5 of this tubular porous membrane can have an inner diameter larger than that of hollow portion 5 of hollow fiber membrane 2 of the first embodiment.

Since other structure and fiinctions are similar to those of the hollow fiber membrane of the above-described embodiment, description thereof is omitted.

### REFERENCE SIGNS LIST

1 membrane distillation module; 2 hollow fiber membrane; 3 base membrane; 4 oil-repellent layer; 5 hollow portion; 6 assembled bundle; 11 circulative cooling pipe; 21 circulative wastewater pipe; 50 wastewater treatment apparatus; HW wastewater; CW treated liquid; S steam.

1. A method for purifying wastewater containing an oil component, a salt component, and an organic matter produced when extracting petroleum from a stratum or a bedrock layer, comprising:
subjecting wastewater separated after recovering oil from oil-containing mixed water extracted from an oil well by a separator, to membrane distillation using a fluorine-based resin hydrophobic porous membrane made of one of PTFE (polytetrafluoroethylene), PVDF (polyvinylidene difluoride) and PCTFE (polychlorotrifluoroethylene) and having a practical maximum operating temperature exceeding 100° C.; and
simultaneously removing the oil component, the salt component and the organic matter contained in said wastewater.

2. The method according to claim 1, further comprising:
flowing said wastewater held at 60° C. to 100° C. on one surface side of said hydrophobic porous membrane at a pressure A by a pump; and
flowing treated liquid held at 5° C. to 40° C. on the other surface side at a pressure B by a pump, wherein
a relation of pressure A<pressure B is met.

3. The method according to claim 1, wherein each of the oil component, the organic matter including naphthenic acid, and the salt component contained in treated liquid having been subjected to said membrane distillation is reduced to less than 1 mg/l.

4. The method according to claim 1, comprising:
discharging wastewater and treated liquid from membrane distillation module during stop of circulation of said wastewater and said treated liquid, and
thereafter blowing dry air.

5. The method according to claim 1, comprising subjecting the wastewater to membrane distillation, the wastewater containing an oil component, a salt component and an organic matter produced in a step of producing oil including heavy oil, shale oil, and oil produced from shale gas.

6. A membrane distillation module for use in the method as defined in claim 1, wherein an oil-repellent layer is provided on a surface of said hydrophobic porous membrane made of fluorine-based resin to be in contact with said wastewater, said oil-repellent layer holding an oil-repellent polymer.

7. The membrane distillation module according to claim 6, wherein
said hydrophobic porous membrane is implemented by one of (1) a hollow fiber membrane, (2) a tubular porous membrane obtained by winding a porous sheet and securing wound ends by sealing to represent a cylindrical shape, and (3) a bag-like composite membrane obtained by sealing, such as by heat sealing, both ends of a single porous sheet or two porous membranes laminated on both surfaces of a dissimilar material, such as a nonwoven fabric, and provided with slits of a specified width, a flow path material, such as a net, being included on the inner side of said composite membrane, and
in said hydrophobic porous membrane, a circulative path for high-temperature wastewater is provided on an outer peripheral surface where said oil-repellent layer is provided, and a hollow portion surrounded by an inner peripheral surface serves as a circulative path for cooling water.

8. A wastewater treatment apparatus comprising the membrane distillation module as defined in claim 6,
a wastewater reservoir, a pump and a heater being inserted in a circulative path for said wastewater, said wastewater reservoir being exposed to the atmosphere,
a heat exchanger, a treated liquid tank and a pump being inserted in a circulative path for treated liquid, treated liquid produced from steam having permeated through said hydrophobic porous membrane being adjusted in temperature by said heat exchanger and captured into said treated liquid tank, part of the treated liquid stored in the treated liquid tank being supplied by said pump to said circulative path to be used for liquefaction of the steam having permeated through said hydrophobic porous membrane.
